(19) United States
(12) Patent Application Publication
(10) Pub. No.: US 2014/0023165 A1
(43) Pub. Date: Jan. 23, 2014

(54) OFDM MODULATION SIGNAL DEMODULATOR, RECEIVING APPARATUS, AND RECEIVING AND DISPLAYING APPARATUS

(71) Applicant: LAPIS Semiconductor Co., Ltd., Yokohama (JP)

(72) Inventor: Hiroji AKAHORI, Yokohama (JP)

(21) Appl. No.: 13/942,807

(22) Filed: Jul. 16, 2013

(30) Foreign Application Priority Data
Jul. 23, 2012 (JP) 2012-162810

(51) Int. Cl. H04L 27/26

(52) U.S. Cl. CPC H04L 27/2649
USPC 375/340

(57) ABSTRACT

An OFDM modulation signal receiving apparatus by which a user can generally grasp a reception state of an OFDM modulation signal and take measures to improve the reception quality thereof. The OFDM modulation signal receiving apparatus includes: a demodulating part that demodulates an OFDM modulation signal to obtain a demodulation signal value on a modulation coordinate for each sub carrier; an intra-interval total sum value calculating part that sums up, for each frequency distribution interval of the sub carriers, comparison result values obtained by comparing the sub carrier signal value to a predetermined determination value to calculate an intra-interval total sum value of each frequency distribution interval; and a selection storage part that stores a piece of noise level data according to the intra-interval total sum value for each frequency distribution interval.

### BACKGROUND OF THE INVENTION

1. Field of the Invention

The present invention relates to an orthogonal frequency-division multiplexing (OFDM) demodulator for demodulating a signal modulated by OFDM, a receiving apparatus including the same, and a receiving and displaying apparatus further having a display function based on a decoded signal.

2. Description of the Related Art

Various noises may occur in an apparatus including an OFDM demodulator. In a case where an apparatus includes a CPU which performs a high-load operation, for example, a noise may occur due to the operation of the CPU. Also, in a case where the apparatus is a car navigation apparatus, a noise may occur also from an electronically-controlled system of an automobile equipped with the apparatus. When the OFDM demodulator is not properly functioning, a noise causing poor reception should be identified among such various noises unexpected when designed, and a measure against the noise should be taken. In Japanese Patent Application Laid-Open No. 2004-201003, for example, there is disclosed a technique in which: characteristic patterns, corresponding to a plurality of expected causes for poor reception, are stored into a database in advance; and a characteristic pattern, obtained from an actually-received OFDM modulation signal, is compared with the stored characteristic patterns in order to identify the cause of poor reception.

### SUMMARY OF THE INVENTION

In general, noise frequencies are different from one another depending on the types or conditions of sources thereof. It is considered that a given noise source generates a noise (hereinafter referred to as a spurious noise) at a specific frequency. During a developmental process or an actual use of an apparatus including an OFDM demodulator, however, it is difficult to predict in advance the types or conditions of all spurious noises. Thus, according to a method of compiling in advance a database of only specific patterns and comparing the pattern of an actually-received OFDM modulation signal with the specific patterns in the database as in the technique disclosed in Japanese Patent Application Laid-Open No. 2004-201003, it is considered to be difficult to identify the cause of poor reception and provide information, which can be used to improve the communication quality, to a user.

The present invention has been achieved in view of the foregoing problems. It is an object of the present invention to provide an OFDM modulation signal demodulator, receiving apparatus, and receiving and displaying apparatus, capable of providing information, with which the cause of poor reception can be identified, to a user and thereby improving the communication quality.

The OFDM modulation signal demodulator according to the present invention is an OFDM modulation signal demodulator for demodulating an OFDM modulation signal, comprising: a demodulating part that demodulates the OFDM modulation signal to obtain a demodulation signal value on a modulation coordinate for each sub carrier; an intra-interval total sum value calculating part that sums up, for each frequency distribution interval of the sub carriers, comparison result values obtained by comparing the demodulation signal value with a predetermined determination value to calculate an intra-interval total sum value of each frequency distribution interval; and a selection storage part that stores a piece of noise level data according to the intra-interval total sum value for each frequency distribution interval.

The OFDM modulation signal receiving apparatus according to the present invention is an OFDM modulation signal receiving apparatus for receiving and demodulating an OFDM modulation signal, comprising: a demodulating part that demodulates the OFDM modulation signal to obtain a demodulation signal value on a modulation coordinate for each sub carrier; an intra-interval total sum value calculating part that sums up, for each frequency distribution interval of the sub carriers, comparison result values obtained by comparing the demodulation signal value with a predetermined determination value to calculate an intra-interval total sum value of each frequency distribution interval; and an output part that selects and outputs, for each frequency distribution interval, a piece of noise level data among a plurality of pieces of noise level data according to the intra-interval total sum value.

The OFDM modulation signal receiving and displaying apparatus according to the present invention is an OFDM modulation signal receiving and displaying apparatus for providing a display based on a decoded signal obtained by receiving, demodulating, and decoding an OFDM modulation signal, the OFDM modulation signal receiving and displaying apparatus comprising: a demodulating part that demodulates the OFDM modulation signal to obtain a demodulation signal value on a modulation coordinate for each sub carrier; an intra-interval total sum value calculating part that sums up, for each frequency distribution interval of the sub carriers, comparison result values obtained by comparing the demodulation signal value with a predetermined determination value to calculate an intra-interval total sum value of each frequency distribution interval; and a selection notification part that makes a noise level notification in each frequency distribution interval on the basis of a noise level selected according to the intra-interval total sum value.

The OFDM modulation signal demodulator, receiving apparatus, and receiving and displaying apparatus according to the present invention facilitate a user to generally grasp a state of occurrence of noise and a noise level thereof for each frequency distribution interval and take measures for improving reception quality.

In particular, if the OFDM modulation signal demodulator according to the present invention is mounted on a mobile unit, it is possible to generally grasp the reception state which varies with actual movement, and take measures such as adjusting a relative position between the OFDM modulation signal demodulator and other electrical equipment arranged in the mobile unit.

### BRIEF DESCRIPTION OF THE DRAWINGS

FIG. 1 is a block diagram showing the configuration of an OFDM modulation signal receiving apparatus according to an embodiment of the present invention;

FIG. 2A is a time chart showing an OFDM transmission signal, FIG. 2B is a time chart showing spurious noises, FIG. 2C is a time chart illustrating an OFDM reception signal;

FIG. 3 is a diagram showing relationships between a constellation and noise determination values;

FIG. 4 is a diagram showing coordinates and vectors on the constellation about a demodulation signal and a noise;

FIG. 5A is a time chart showing the OFDM reception signal and the spurious noises, FIG. 5B is a diagram showing an example of a screen display based on noise levels; and

FIG. 6 is a diagram showing an exemplary correspondence between noise levels and screen display patterns.

### DETAILED DESCRIPTION OF THE INVENTION

An embodiment according to the present invention will now be described in detail with reference to the accompanying drawings.

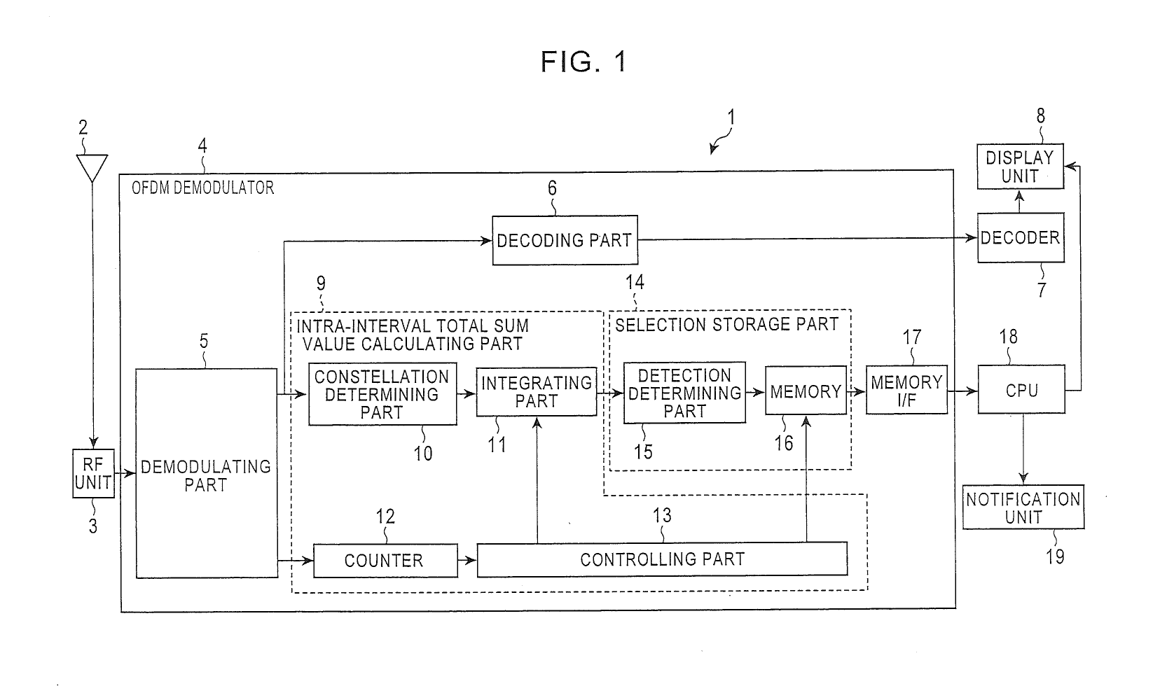

FIG. 1 shows the configuration of an OFDM modulation signal receiving and displaying apparatus 1 (hereinafter referred to simply as receiving apparatus 1) which is an embodiment of the present invention. The receiving apparatus 1 includes an antenna 2 and can acquire an OFDM modulation signal. The receiving apparatus 1 is a car navigation apparatus, for example. The OFDM modulation signals are digital terrestrial broadcasting signals, for example. In this case, a display unit 8 to be described later can selectively display map information provided by a car navigation function and a video image of a digital terrestrial broadcast program.

An RF unit 3 takes various reception signals, acquired by the antenna 2 as input signals and applies predetermined signal processing thereto. The thus obtained signals are supplied to an OFDM demodulator 4. Specifically, the RF unit 3 initially amplifies reception signals, which are weak signals. Thereafter, the RF unit 3 converts the amplified signals into intermediate frequency signals. Next, the RF unit 3 selects a channel signal from the intermediate frequency signals. The RF unit 3 further amplifies the selected channel signal and supplies it to the OFDM demodulator 4.

The OFDM demodulator 4 demodulates and decodes the OFDM modulation signal supplied from the RF unit 3, and supplies the thus obtained digital signal to a decoder 7 in the subsequent stage. The OFDM demodulator 4 can be configured as a single LSI, i.e., a semiconductor device.

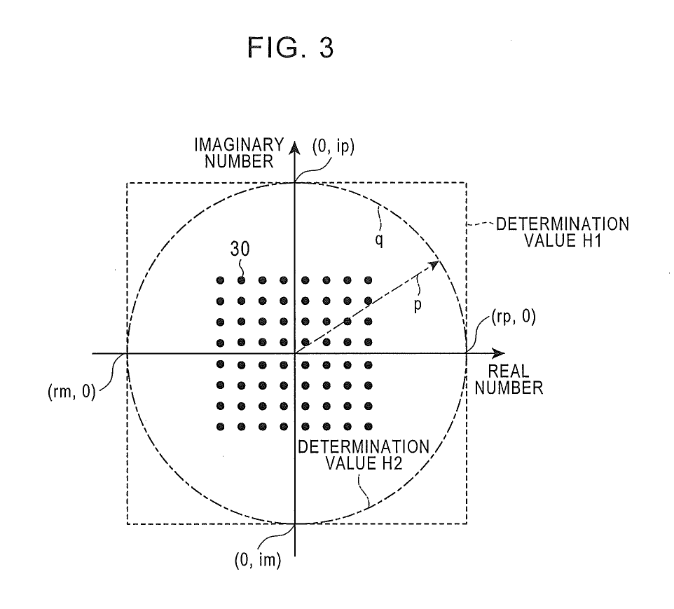

A demodulating part 5 demodulates the OFDM modulation signal supplied from the RF unit 3 to obtain a signal on a complex modulation coordinate (hereinafter referred to as demodulation signal) for each sub carrier serving as a carrier of this modulation signal. In other words, the demodulating part 5 performs what is called de-mapping on the OFDM modulation signal and converts the resultant signal into a demodulation signal corresponding to the complex coordinate position of the modulation signal. The complex modulation coordinates form what is called a constellation (see FIG. 3). A signal value of the demodulation signal is expressed as a coordinate on the constellation. Note that this demodulating processing is performed by sequentially applying processing including typical serial-parallel conversion, a discrete Fourier transform, equalization, and parallel-serial conversion to the OFDM modulation signal.

A decoding part 6 decodes the demodulation signal and supplies the resulting digital signal to the decoder 7 in the subsequent stage. The decoding part 6 performs the decoding processing by sequentially applying, for example, processing for error correction decoding (such as deinterleaving processing and Viterbi decoding processing), energy inverse diffusion processing, RS decoding processing, and signal format conversion processing to the demodulation signal.

The decoder 7 reproduces a video image on the basis of the digital signal supplied from the decoding part 6.

The display unit 8 displays the video image reproduced by the decoder 7. The display unit 8 is a liquid crystal display, for example.

An intra-interval total sum value calculating part 9 sums up comparison result values obtained by comparing demodulation signal values with a predetermined determination value in each predetermined frequency interval (hereinafter referred to as integral interval) to calculate an intra-interval total sum value of each integral interval. The intra-interval total sum value is calculated as the total number of demodulation signal values greater than the determination value among the demodulation signal values included in an integral interval. Two or more integral intervals are included in a frequency distribution interval of all sub carriers. The range and number of integral intervals are set by a controlling part 13 to be described later. The intra-interval total sum value calculating part 9 can be configured by a constellation determining part 10, an integrating part 11, a counter 12, and the controlling part 13, for example.

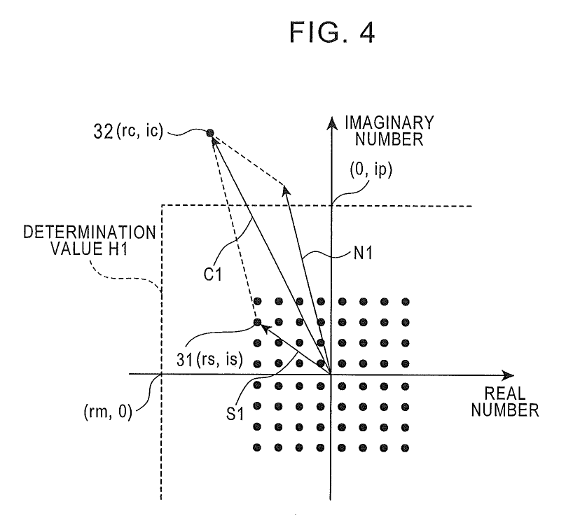

The constellation determining part 10 compares a signal value on a complex modulation coordinate for a demodulation signal supplied from the demodulating part 5 with a predetermined determination value, thereby obtaining a comparison result value. Specifically, the constellation determining part 10 determines, for each sub carrier, whether or not a signal value on a complex modulation coordinate for a demodulation signal supplied from the demodulating part 5 is greater than the predetermined determination value. If a large noise is generated in the integral interval about which the determination is made, the signal value thereof is greater than the determination value. The constellation determining part 10 outputs a comparison result value showing the result of such a determination. The comparison result values are expressed as binary data. For example, when the signal value is determined to be greater than the determination value (hereinafter referred to as strong noise determination), the comparison result value is “1.” When the signal value is determined to be smaller than or equal to the determination value (hereinafter referred to as weak noise determination), on the other hand, the comparison result value is “0.” Note that such a determination will be described later in detail (see FIG. 3 and FIG. 4). The constellation determining part 10 supplies the determination result to the integrating part 11.

The integrating part 11 obtains an intra-interval total sum value by summing up the comparison result values in each integral interval. Specifically, the integrating part 11 sums up the number of strong noise determinations in each integral interval to obtain an intra-interval total sum value. In other words, the integrating part 11 calculates the total number of signal values greater than the determination value (i.e., signal values with strong noise determinations) among a plurality of demodulation signal values included in an integral interval as an intra-interval total sum value. The integrating part 11 supplies the intra-interval total sum value of each integral interval to a detection determining part 15.

The counter 12 generates a count value for dividing all or part of the range of the frequency distribution interval of all sub carriers into a plurality of integral intervals. A user may input an instruction for setting the range and number of the integral intervals into the counter 12 in advance.

The controlling part 13 sets the range and number of the integral intervals for the integrating part 11 according to the count value of the counter 12. Moreover, the controlling part 13 also controls timing of access to the memory 16 and designation of the storage area of the noise level data.

A selection storage part 14 selects and stores one of a plurality of pieces of noise level data according to the intra-interval total sum value in each frequency distribution interval. The selection storage part 14 can be configured by the detection determining part 15 and the memory 16, for example.

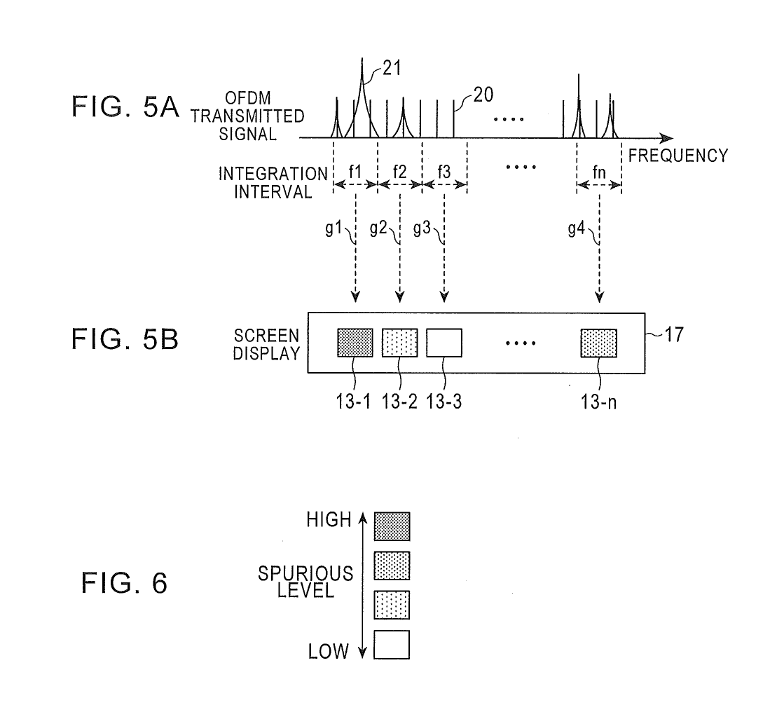

The detection determining part 15 selects one of a plurality of pieces of noise level data having respective different displays in each integral interval according to the intra-interval total sum value, which is supplied from the integrating part 11 for each integral interval. Such selecting processing will be described later in detail (see FIGS. 5A, 5B and FIG. 6). The detection determining part 15 holds the plurality of pieces of noise level data in advance.

The memory 16 stores the noise level data selected in each integral interval. The memory 16 is a cache memory in an LSI, for example.

A memory I/F 17 is an interface between the memory 16 and outside.

A CPU 18 reads the noise level data of each integral interval stored into the memory 16 through the memory I/F 17 at predetermined intervals such as every other second. The CPU 18 then supplies the read data to a notification unit 19.

The notification unit 19 notifies the user of an intensity of noise generated in the sub carrier frequency distribution interval on the basis of the noise level data supplied from the CPU 18. The notification unit 19 makes the notification, for example, by means of a screen display or sound. The notification unit 19 makes the notification at predetermined intervals, for example, every other second. The notification unit 19 may be provided as a display or speaker in the receiving apparatus 1. Alternatively, the notification unit 19 may be an apparatus having a display function, such as a personal computer, provided outside the receiving apparatus 1. The notification will be described later in detail (see FIGS. 5A, 5B and FIG. 6).

Hereinafter, the above-described functional blocks 15 to 18 are collectively referred to as an output part, and the above-described functional blocks 15 to 19 are collectively referred to as a selection notification part.

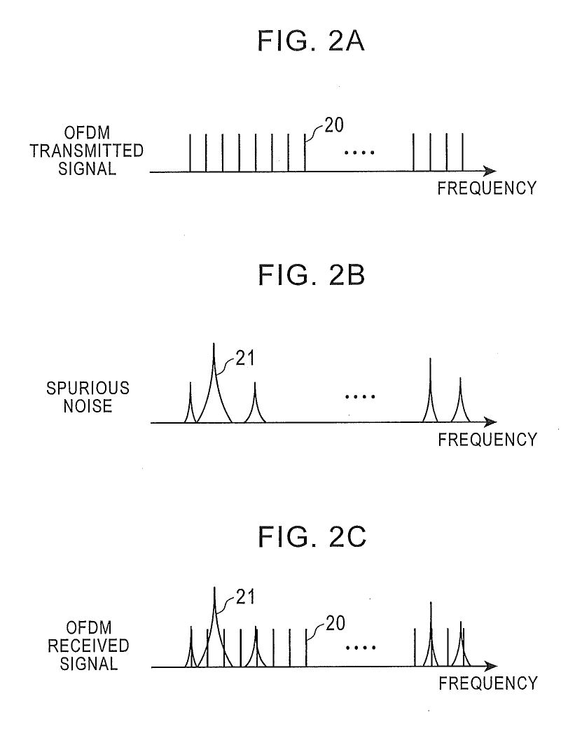

Hereinafter, with reference to FIG. 2, a relationship between an OFDM modulation signal and a noise will be described. As shown in FIG. 2A, in an OFDM transmission signal, a plurality of sub carriers 20 are distributed on a frequency axis to be orthogonal to each other. In the case of digital terrestrial broadcasting, for example, communications are performed by means of 5616 sub carriers at periods of approximately 1 ms. In the receiving apparatus 1, spurious noises 21 may be generated in the frequency distribution interval of the sub carriers 20 as shown in FIG. 2B. For example, the CPU 18 which performs high-load processing can be a noise source. In a case where the receiving apparatus 1 is a car navigation apparatus, an electronically-controlled system of an automobile can also be a noise source. Since the frequency of the spurious noise 21 varies depending on the operating frequency of the noise source or the like, noise peaks may be generated at a plurality of frequencies. As shown in FIG. 2C, a noise influence level varies for each sub carrier 20 in an OFDM reception signal.

With reference to FIG. 3, relationships between a constellation and predetermined determination values will now be described below. 64 complex coordinates 30 are shown on the constellation with a horizontal axis thereof showing real numbers and a vertical axis thereof showing imaginary numbers. FIG. 3 shows an exemplary case where 64-QAM is employed as its modulation scheme. Each of the complex coordinates 30 is located at a position corresponding to a sub carrier modulation phase and a sub carrier modulation amplitude. Moreover, each of the complex coordinates 30 is correlated to one of digital data values in a range of from “000000” to “111111.” The signal value of each sub carrier corresponds to one of the 64 complex coordinates 30 when the influence of noise is not received.

FIG. 3 shows two determination values H1 and H2. In a case where the determination value H1 is used, a positive threshold rp and a negative threshold rm on the axis of real numbers, and a positive threshold ip and a negative threshold im on the axis of imaginary numbers are set in advance. The constellation determining part 10 determines if the real number coordinate value of a demodulation signal is greater than or equal to the positive threshold rp or smaller than or equal to the negative threshold rm and also determines if the imaginary number coordinate value of the demodulation signal is greater than or equal to the positive threshold ip or smaller than or equal to the negative threshold im. In a case where the demodulation signal value matches any of these conditions, the constellation determining part 10 issues the strong noise determination as the determination result thereof. In a case where the demodulation signal value does not match these conditions, the constellation determining part 10 issues the weak noise determination as the determination result thereof.

In a case where the determination value H2 is used, coordinate values on a circle q with a radius corresponding to an amplitude p of a sub carrier are set in advance as thresholds. In this case, the constellation determining part 10 determines if the magnitude of a vector of a demodulation signal on a complex coordinate is greater than or equal to the amplitude p of the circle q. In a case where the magnitude of the vector is greater than or equal to the amplitude p, the constellation determining part 10 issues the strong noise determination as the determination result thereof. In a case where the magnitude of the vector is smaller than the amplitude p, the constellation determining part 10 issues the weak noise determination as the determination result thereof.

The constellation determining part 10 performs these determinations for each sub carrier. Also, the constellation determining part 10 performs these determinations for each data symbol in an OFDM modulation signal.

With reference to FIG. 4, an example of determination processing performed by the constellation determining part 10 will now be described below. Here, a description will be made with regard to the case where the determination value H1 is used.

FIG. 4 shows a coordinate 31 and a vector S1 on the constellation about a demodulation signal that is supposed to be obtained when the demodulating part 5 applies demodulating processing to a given sub carrier. In a case where no noise is generated in the frequency distribution interval of this sub carrier, the coordinate of the demodulation signal actually obtained by the demodulating processing is identical to the coordinate 31. The real number coordinate value rs of the coordinate 31 is a value greater than the negative threshold rm on the axis of real numbers, and the imaginary number coordinate value is of the coordinate 31 is a value smaller than the positive threshold ip on the axis of imaginary numbers. Thus, the constellation determining part 10 issues the weak noise determination as the determination result thereof. The constellation determining part 10 supplies, to the integrating part 11, information regarding the frequency distribution interval of this sub carrier as well as information indicating that the determination result was the weak noise determination (for example, the data value of “0”).

On the other hand, in a case where a noise, indicated by the vector N1, is generated in the frequency distribution interval of the above-described sub carrier, a coordinate 32 of the demodulation signal actually obtained by the demodulating processing is placed at a position indicated by a resultant vector C1 of the vector S1 and a vector N1. The real number coordinate value rc of the coordinate 32 is not a value smaller than or equal to the negative threshold rm on the axis of real numbers. However, the imaginary number coordinate value is of the coordinate 32 is a value greater than or equal to the positive threshold ip on the axis of imaginary numbers. Thus, the constellation determining part 10 issues the strong noise determination as the determination result thereof. The constellation determining part 10 supplies, to the integrating part 11, information regarding the frequency distribution interval of the above-described sub carrier as well as information indicating that the determination result was the strong noise determination (for example, the data value of “1”).

The constellation determining part 10 similarly performs such a determination for each sub carrier, and supplies the determination result to the integrating part 11. The constellation determining part 10 also performs the above-described processing for each data symbol of an OFDM modulation signal. Although the above-described example discussed an exemplary case where the determination value H1 is used, the constellation determining part 10 determines in a similar fashion whether or not the demodulation signal value is greater than the determination value H2 also when the determination value H2 shown in FIG. 3 is used.

With reference to FIG. 5, a noise intensity determination performed by the OFDM demodulator 4 and notification processing based on the determination result thereof will now be described below.

First, the demodulating part 5 demodulates an OFDM modulation signal supplied from the RF unit 3 to obtain a demodulation signal for each sub carrier. As shown in FIG. 5A, a plurality of sub carriers 20 are distributed on the frequency axis to be orthogonal to each other. A plurality of spurious noises 21 having different peak frequencies may be generated in the frequency distribution interval of the sub carriers 20. Thus, the influence level of the spurious noise 21 on the demodulation signal varies for each sub carrier 20.

Next, the constellation determining part 10 determines whether or not the signal value of the demodulation signal supplied from the demodulating part 5 is greater than the determination value on the constellation for each sub carrier 20. Depending on the magnitude of the spurious noise 21 generated in the frequency distribution interval of the sub carrier 20 about which the above-described determination is made, the constellation determining part 10 issues, as the determination result, either the strong noise determination or the weak noise determination.

Next, for each of integral intervals f1, f2, . . . , fn, which are set by the controlling part 13 according to the count value of the counter 12, the integrating part 11 calculates the total number of signal values determined to be strong noise determinations to obtain intra-interval total sum values g1, g2, . . . , gn (n is an integer greater than or equal to 2). In the case of the example shown in FIG. 5A, each sub carrier 20 belonging to the integral interval f1 is influenced by the spurious noise 21. In the integral interval f2, on the other hand, the number of sub carriers 20 influenced by the spurious noise 21 is relatively fewer than that in the integral interval f1. Thus, the intra-interval total sum value g2 in the integral interval f2 is smaller than the intra-interval total sum value g1 in the integral interval f1.

Next, the detection determining part 15 selects a piece of noise level data for each integral interval according to the intra-interval total sum values g1 to gn in the integral intervals, which are calculated by the integrating part 11. The detection determining part 15 holds a table that associates intra-interval total sum values with noise level data in advance in such a manner that the noise level data d1 is associated with the intra-interval total sum value which is smaller than or equal to 125, the noise level data d2 is associated with the intra-interval total sum value is in a range of 126 to 250, the noise level data d3 is associated with the intra-interval total sum value is in a range of 251 to 375, and the noise level data d4 is associated with the intra-interval total sum value is greater than or equal to 376, for example. In a case where the intra-interval total sum value g1 is 400 and the intra-interval total sum value g2 is 300, for example, the detection determining part 15 selects the noise level data d4 for the integral interval f1 and selects the noise level data d3 for the integral interval f2. The noise level data d1, d2, d3, and d4 can be expressed, for example, by binary data “00,” “01,” “10,” and “11,” respectively. The noise level data of each integral interval is stored into the memory 16. The storage area of the noise level data is specified by the controlling part 13.

The demodulating part 5, the constellation determining part 10, the integrating part 11, and the detection determining part 15 perform the above-described processing periodically, e.g., at intervals of one second. The memory 16 stores the noise level data of each integral interval in each period.

The CPU 18 reads the noise level data of the integral intervals belonging to a single period from the memory 16 periodically, e.g., at intervals of one second. The noise level data is read out via the memory I/F 17. The CPU 18 supplies the read noise level data to the notification unit 19.

Next, the notification unit 19 notifies the user of the noise level data supplied from the CPU 18. As shown in FIG. 5B, the notification unit 19 may make the notification by providing noise level displays 13-1, 13-2, . . . , 13-n on a screen. The noise level displays 13-1, 13-2, . . . , 13-n correspond to the integral intervals f1, f2, . . . , fn, respectively. In other words, the noise levels of the respective integral intervals are displayed and juxtaposed on a screen over a range from a low-frequency region to a high-frequency region in the frequency distribution interval of the sub carriers about which the determination is made.

As shown in FIG. 5C, the noise levels are displayed by using different color densities. For example, it is set in advance to display higher spurious noise levels in deeper colors. In the case of the example shown in FIGS. 5A and 5B, the intra-interval total sum value g1 in the integral interval f1 is relatively large. Thus, the noise level display 13-1 is in deep color. On the other hand, since the intra-interval total sum value g2 in the integral interval f2 is relatively small, the noise level display 13-2 is in paler color than that of the noise level display 13-1. A user or developer of the receiving apparatus 1 can recognize at a glance that a spurious noise is being generated in which frequency band by means of the color densities of the noise level displays. The noise level displays are updated and displayed at each reading period of the noise level data by the CPU 18.

As described above, according to the receiving apparatus 1 of the present embodiment, the demodulation signal value for each sub carrier obtained by demodulating the received OFDM modulation signal is compared with the determination value on the constellation. From among the demodulation signal values, the number of signal values which are greater than the determination value is calculated as the intra-interval total sum value at predetermined frequency intervals. Furthermore, a piece of noise level data is selected from the plurality of pieces of noise level data according to the intra-interval total sum value. Such an operation is executed at predetermined periods, and the selected noise level data is successively stored into the memory in the receiving apparatus 1.

As described above, the receiving apparatus 1 of the present embodiment provides information, with which the cause of poor reception can be identified, not by using the final decoded signals but by using the demodulation signal obtained by the demodulating processing which is a previous step of the decoding processing. In particular, since the demodulation signal value is compared with the determination value on the constellation for each sub carrier distributed on the frequency axis, it is possible to grasp which frequency has a large spurious noise. Such an effect cannot be obtained only by determining whether the final decoded signal is good or not. Such an effect can be obtained only if the configuration of the receiving apparatus 1 is employed.

Moreover, according to the receiving apparatus 1, the memory 16 stores, not the noise values themselves for the sub carriers, but data representing a distributed state of the spurious noises on the frequency axis. In other words, the number of the strong noise determinations is obtained for each predetermined integral interval and a piece of noise level data corresponding to the number is stored into the memory 16 for each integral interval. Such an operation compresses a plurality of noise intensity values included in the single integral interval to obtain noise level information of a single integral interval. In the case of the digital terrestrial broadcasting, 5616 sub carriers are transmitted at periods of about 1 ms. If the noise intensity for each sub carrier was expressed, for example, by eight bits of numerical value without information compression, the amount of data needed would be 8×1k×5616=approximately 45 Mbit/s, thereby exceeding the amount of information transmitted by the digital terrestrial broadcasting, which is approximately 20 Mbit/s. Thus, the operation itself of the CPU 18 reading the noise intensity values can be a new source of spurious noises. Thus, the receiving apparatus 1 of the present embodiment can also solve such a problem by means of the information compression.

Also, according to the receiving apparatus 1, reception state information, which can be used to identify the cause of poor reception and thereby improve the communication quality thereof, can be provided to the user on the basis of the data stored in the memory 16. For example, the receiving apparatus 1 can show to the user a noise level distribution in the frequency distribution interval of sub carriers by means of a method such as a screen display. Here, the noise level display is produced for each predetermined frequency interval over a range of from the low-frequency region to the high-frequency region. Thus, the user or developer of the receiving apparatus 1 can visually and easily recognize that how big spurious noise is being generated in which frequency band. For example, in a case where the receiving apparatus 1 is a car navigation apparatus, the developer of the receiving apparatus 1 can check the noise condition as needed while travelling on a road in an automobile equipped with the receiving apparatus 1. In other words, instead of using the OFDM demodulator 4 alone, the OFDM demodulator 4 can be incorporated into the receiving apparatus 1. It is further possible to easily observe spurious noises generated in the actual use of the receiving apparatus 1 and take a measure against it.

In general, the frequency of a spurious noise is varied depending on the noise source thereof. Thus, a user or the like can identify the noise source from the noise level distribution on the frequency axis and take a proper measure against noise. Examples of the measures against noise include adjustments in the directional characteristics of the antenna 2, the operation characteristics of the CPU, another element or device included in the receiving apparatus 1, the mounting position of the receiving apparatus 1 in the vehicle, the operation characteristics of the electronic control system in a vehicle, and the like. Such adjustments can suppress the occurrence of the spurious noise, thereby ultimately obtaining the desired OFDM receiving and demodulating system.

The above-described embodiment has dealt with the case where the intra-interval total sum value calculated by the intra-interval total sum value calculating part 9 is the total number of the demodulation signal values, which are greater than a predetermined determination value (the demodulation signals determined to be strong noise determination) among demodulation signal values included in a single integral interval. However, the present invention is not limited thereto. The intra-interval total sum value calculating part 9 may calculate, as an intra-interval total sum value, an integrated value of differences between a predetermined determination value and the respective demodulation signal values which are greater than the predetermined determination value among the demodulation signal values included in a single integral interval. In this case, the constellation determining part 10 outputs the comparison result values showing the difference between the determination value and the demodulation signal value determined to be strong noise determination. The comparison result values are expressed as difference values showing the differences themselves. The integrating part 11 integrates the difference values in each integral interval to obtain an intra-interval total sum value. The integrating part 11 supplies the intra-interval total sum value of each integral interval to the detection determining part 15. Such an operation can also provide effects similar to those of the above-described embodiment.

Although the above-described embodiment has dealt with the case where noise levels are displayed stepwise by using different color densities, the present invention is not limited thereto. For example, the noise level of each integral interval may be displayed stepwise by using a plurality of types of color, a plurality of display patterns, a plurality of characters, or a combination of these. Moreover, although the above-described embodiment has dealt with the case where the noise levels are displayed in four levels, the present invention is not limited thereto. For example, it is possible to employ a two-level display consisting of a display which indicates that the noise level falls within an acceptable range and a display which indicates that the noise level falls outside the acceptable range (for example, displays of “o” and “x”). Alternatively, a single display color may be used to display only an integral interval where the noise level falls outside the acceptable range by blinking. Moreover, although the above-described embodiment has dealt with the case where a screen display is used to make a notification to the user or others, the present invention is not limited thereto. For example, sound may be used to make a notification. In such a case, the notification unit 19 can be configured in such a manner that a sound type or a sound level can be changed according to a position, on the frequency axis, of the integral interval having the strong noise determination. For example, the notification unit 19 can be configured in such a manner that a low pitch sound is outputted when the integral interval, having the strong noise determination, exists mainly in the low-frequency region and a high pitch sound is outputted when the integral interval, having the strong noise determination, exists mainly in the high-frequency region.

Moreover, although the above-described embodiment has dealt with the case where the notification unit 19 makes a notification of the noise intensity by means of a screen display or the like, the present invention is not limited thereto. The display unit 8 may make the notification by using a screen display. In such a case, the CPU 18 reads the noise level data from the memory 16, and supplies a display signal according to the data to the display unit 8. The display signal is a signal for making the display unit 8 display on a screen (the display shown in FIG. 5B, for example) showing the noise levels by using different color densities or the like. Such an operation can also provide effects similar to those of the above-described embodiment.

This application is based on Japanese Patent Application No. 2012-162810 which is herein incorporated by reference.

What is claimed is:

1. An OFDM modulation signal demodulator for demodulating an OFDM modulation signal, comprising:
a demodulating part that demodulates the OFDM modulation signal to obtain a demodulation signal value on a modulation coordinate for each sub carrier;
an intra-interval total sum value calculating part that sums u, for each frequency distribution interval of the sub carriers, comparison result values obtained by comparing the demodulation signal value with a predetermined determination value to calculate an intra-interval total sum value of each frequency distribution interval; and
a selection storage part that stores a piece of noise level data according to the intra-interval total sum value for each frequency distribution interval.

2. The OFDM modulation signal demodulator according to claim 1, wherein the intra-interval total sum value is the total number of demodulation signal values greater than the determination value among the demodulation signal values included in a frequency distribution interval.

3. The OFDM modulation signal demodulator according to claim 1, wherein the intra-interval total sum value is an integrated value of differences between the determination value and respective demodulation signal values greater than the determination value among the demodulation signal values included in a frequency distribution interval.

4. The OFDM modulation signal demodulator according to claim 1, wherein the modulation coordinates form a constellation in a digital modulation scheme, and
the determination value is defined by a coordinate on the constellation.

5. The OFDM modulation signal demodulator according to claim 1, wherein the demodulating part demodulates the OFDM modulation signal for each data symbol thereof, and
for each data symbol, the intra-interval total sum value calculating part calculates the intra-interval total sum value of each frequency distribution interval.

6. The OFDM modulation signal demodulator according to claim 1, wherein the selection storage part selects, as the piece of noise level data, one of a plurality of pieces of noise level data according to the intra-interval total sum value.

7. An OFDM modulation signal receiving apparatus for receiving and demodulating an OFDM modulation signal, comprising:
a demodulating part that demodulates the OFDM modulation signal to obtain a demodulation signal value on a modulation coordinate for each sub carrier;
an intra-interval total sum value calculating part that sums up, for each frequency distribution interval of the sub carriers, comparison result values obtained by comparing the demodulation signal value with a predetermined determination value to calculate an intra-interval total sum value of each frequency distribution interval; and
an output part that selects and outputs, for each frequency distribution interval, a piece of noise level data among a plurality of pieces of noise level data according to the intra-interval total sum value.

8. The OFDM modulation signal receiving apparatus according to claim 7, wherein the intra-interval total sum value is the total number of demodulation signal values greater than the determination value among the demodulation signal values included in a frequency distribution interval.

9. The OFDM modulation signal receiving apparatus according to claim 7, wherein the intra-interval total sum value is an integrated value of differences between the determination value and respective demodulation signal values greater than the determination value among the demodulation signal values included in a frequency distribution interval.

10. The OFDM modulation signal receiving apparatus according to claim 7, wherein the modulation coordinates form a constellation in a digital modulation scheme, and
the determination value is defined by a coordinate on the constellation.

11. The OFDM modulation signal receiving apparatus according to claim 7, wherein the demodulating part demodulates the OFDM modulation signal for each data symbol thereof, and
for each data symbol, the intra-interval total sum value calculating part calculates the intra-interval total sum value of each frequency distribution interval.

12. The OFDM modulation signal receiving apparatus according to claim 7, wherein the selection storage part selects, as the piece of noise level data, one of a plurality of pieces of noise level data according to the intra-interval total sum value.

13. An OFDM modulation signal receiving and displaying apparatus for providing a display based on a decoded signal obtained by receiving, demodulating, and decoding an OFDM modulation signal, the OFDM modulation signal receiving and displaying apparatus comprising:
a demodulating part that demodulates the OFDM modulation signal to obtain a demodulation signal value on a modulation coordinate for each sub carrier;
an intra-interval total sum value calculating part that sums up, for each frequency distribution interval of the sub carriers, comparison result values obtained by comparing the demodulation signal value with a predetermined determination value to calculate an intra-interval total sum value of each frequency distribution interval; and
a selection notification part that makes a noise level notification in each frequency distribution interval on the basis of a noise level selected according to the intra-interval total sum value.

14. The OFDM modulation signal receiving and displaying apparatus according to claim 13, wherein the intra-interval total sum value is the total number of demodulation signal values greater than the determination value among the demodulation signal values included in a frequency distribution interval.

15. The OFDM modulation signal receiving and displaying apparatus according to claim 13, wherein the intra-interval total sum value is an integrated value of differences between the determination value and respective demodulation signal values greater than the determination value among the demodulation signal values included in a frequency distribution interval.

16. The OFDM modulation signal receiving and displaying apparatus according to claim 13, wherein the noise level notification is made by using a screen display or sound.

17. The OFDM modulation signal receiving and displaying apparatus according to claim 16, wherein the screen display includes a plurality of level display images juxtaposed in order from a low-frequency region to a high-frequency region.

18. The OFDM modulation signal receiving and displaying apparatus according to claim 17, wherein the plurality of level display images include images that are mutually distinguishable by at least one of color density, color type, and display patterns.
